(19) United States
(12) Patent Application Publication
(10) Pub. No.: US 2026/0037526 A1
(43) Pub. Date: Feb. 5, 2026

(54) SYSTEMS AND METHODS FOR DETERMINING CORRELATIONS BETWEEN A PLURALITY OF DISSIMILAR DATA SETS

(71) Applicant: INTRARE S.A.P.I. DE C.V., Mexico City (MX)

(72) Inventors: Marcela Silva Guimarães Vasconcellos, Worcester, MA (US); Hannah Töpler, Mexico City (MX); Andrew Christopher Trapp, Holden, MA (US)

(21) Appl. No.: 19/290,788

(22) Filed: Aug. 5, 2025

Related U.S. Application Data
(60) Provisional application No. 63/679,610, filed on Aug. 5, 2024.

(51) Int. Cl. G06F 16/2457; G06F 16/2455; G06F 16/248; G06F 16/25

(52) U.S. Cl. CPC G06F 16/24578; G06F 16/24565; G06F 16/248; G06F 16/258

(57) ABSTRACT

Systems and methods are disclosed for determining a plurality of best-fit correlations or matches between dissimilar data sets. An example method includes obtaining a first data set and a second data set from data sources. The method may include pre-processing the first data set to convert the received data into a standard format corresponding to attributes. A plurality of subsets corresponding to the second data set may be determined based on the attributes corresponding to the first data set. The method may include determining sets of fit scores individually corresponding to each of the one or more subsets of the first data set. The method may include determining the plurality of best-fit correlations or matches via an integer optimization model and based on the fit scores. The method may include displaying a list of the plurality of best-fit correlations or matches via a graphical user interface.

### CROSS REFERENCE TO RELATED APPLICATION

This application claims priority to, and the benefit of U.S. Provisional Application No. 63/679,610, filed Aug. 5, 2024, titled “SYSTEMS AND METHODS FOR DETERMINING A PLURALITY OF BEST-FIT CORRELATIONS BETWEEN A PLURALITY OF DISSIMILAR DATA SETS,” the disclosure of which is incorporated herein by reference in its entirety.

### TECHNICAL FIELD

The disclosure relates to the field of correlating a plurality of dissimilar data sets. More specifically, the present disclosure relates to systems and associated methods for unbiased and optimized many-to-many correlation of dissimilar data sets.

### BACKGROUND

The process of fulfilling a role or position in an organization, from receiving human capital data to actually filling the role, typically takes a significant amount of time and resources. The filtering and pre-selecting of human assets, especially, often involves sorting through hundreds of applicants. These tasks are still either manual or, in advanced Applicant Tracking Systems (ATS) and other recruitment management systems, managed with filters, keyword algorithms, simple ranking algorithms, and other sub-optimal algorithms. In addition, those asset filtering and pre-selection processes are subject to bias, for example, either by humans when conducted manually and/or by algorithms which reproduce or exacerbate bias. These automated methods generally use information in a way that gives disproportionate advantage to certain demographic groups and a reduced match quality between the expectations of the human assets and the company. Because recommendation systems are greedy in their approach, they will always offer both candidates and companies the matches that appear strongest or have the highest predicted fit. The nature of scarcity and competition, however, implies that not all candidates will be considered for a role, but rather the first few candidates in the suggested ranking will be considered. In other words, for example, the twentieth candidate has a much lower chance of being contacted than the fourth. For candidates, a very competitive candidate will apply to a certain number of positions but will not be interested in considering positions that have lower fits. Traditional recommendation systems will then match candidates with many job openings for which they are not highly competitive, causing such candidates to apply to dozens of jobs before receiving an indication of interest from any employer. Similarly, typical systems might recommend many candidates to recruiters that are not interested in the position, lengthening the recruitment process.

Furthermore, increasingly popular data-based machine learning algorithms are trained on biased data, repeating patterns of systemic injustice found in historical hiring decisions. Furthermore, most of the available job platform solutions are inaccessible. They require higher levels of digital literacy, data access, and sufficiently well-equipped phones that most people do not have. Even if people can use such platforms, most algorithms—based on keywords, rankings, or Large Language Models (LLMs) —perpetuate or even increase bias against them. Additionally, recruiters apply both conscious and unconscious bias against these individuals. Diverse groups are more likely to have little experience with CVs, formal interviews, or lack necessary documents, creating an additional barrier.

Additionally, bias may be inherent whether a unit is filled algorithmically or manually. For example, data used to produce an algorithm to aid in unit fulfillment may utilize data sources that may cause the algorithm to eliminate assets based on one or more factors associated with the asset. Further, bias may exist in other processes similar to job fulfillment, such as in forensic investigations and/or survey scenarios.

### SUMMARY

Thus, there is felt a need to limit the aforementioned problems and drawbacks and provide systems and methods for recruitment that eliminate bias, give marginalized individuals access to high-quality unit fulfillment, and increase matching quality, while saving significant time and resources.

As noted, traditional methods take greedy approaches when correlating dissimilar data sets. For example, they use predictive data-based models to infer a preference list for each job opening. This approach ignores marketplace dynamics and expected preference-based outcomes, which can be modeled through economic models and are proven to have significant effects on practical job-application dynamics. As a result, many assets, especially from diverse communities, are not considered for positions or are ranked lower than appropriate. Additionally, companies receive sub-optimal filtering, ranking, or pre-selection of assets.

Provided herein are systems and methods to address these shortcomings of the art and provide other additional or alternative advantages. The disclosure herein provides one or more embodiments of systems and methods for determining a plurality of, correlations, matches, or “best-fit” correlations (subsequently referred to as matches) between a plurality of dissimilar data sets. The systems and methods use machine learning and deep learning with high-quality, unbiased data to utilize AI or machine learning models for unbiased, fair, and optimized hiring with a symmetric fit score, which serves as a cardinal indicator of preferences for both assets and units. Further, such systems and methods may eliminate or substantially eliminate any algorithmic bias, conscious bias, unconscious bias, and inherent bias, thus enabling unbiased, fair, and optimized hiring.

As noted above, marketplace dynamics and expected preference-based outcomes are increasingly relevant factors for models. Described herein is a new solution, which uses data-based predictive fit scores to infer a preference list not only for the units that are posted by the recruiters but also for each asset. It further builds on these results and generates correlations using integer optimization to model a bipartite b-matching problem, which allows the recommendations to also consider market dynamics. The model leveraged in this solution is the first many-to-many stable correlation formulation using integer optimization. This formulation allows the solution the flexibility to incorporate a combination of utilitarian and Rawlsian objective functions to balance different groups' access to opportunities, significantly increasing the fairness outcomes of the output recommendations. Through this model and the associated programming language implementation, the solution enforces stability, which is a property that guarantees that outcomes are envy-free, that is, it cannot be more advantageous for unit-asset pairs to form their own correlations outside of the system.

In embodiments, such a system may assume that candidates may consider a top number of offers (for example, that number being k) and that companies may consider a top number of candidates (for example, that number being l). In such embodiments, the systems and methods described herein may analyze a percentage of candidates that are matched to realistic jobs. Experimentation shows that the larger the market size (such as the number of candidates and job openings), the more a small number of candidates that are repeatedly recommended to jobs, thus occupying recruiters' time and taking potential job opportunities from realistic candidates. Briefly described, according to various aspects, the present disclosure includes systems and methods for determining a plurality of matches between a plurality of dissimilar data sets. For example, a first data set can be received from one or more data sources, such as a network, an information handling system, a non-transitory machine-readable storage medium, or other data sources as will be understood by those skilled in the art. The first data set can consist of one or more entries each corresponding to one or more of a plurality of attributes. In one embodiment, the first data set can include a plurality of asset profiles, each including one or more asset profile aspects, where the term “asset” refers to an employee, a job seeker, a candidate for a position, or a potential user seeking a new role. Likewise, a second data set can be received from one or more data sources, such as a network, an information handling system, a non-transitory machine-readable storage medium, or other data sources as will be understood by those skilled in the art. In one embodiment, the second data set can include data indicative of one or more units, where the term ‘unit’ refers to a job position within a division or department, a job role within a division or department, or an assigned duty or responsibility to be held by an employee. Furthermore, pre-processing may be performed to convert the received data describing the second data set into a standard format corresponding to a plurality of attributes. Additionally, in some embodiments, pre-processing may be performed to convert the first data set into a standard format corresponding to a plurality of attributes. A related data set of the first data set may then be determined based on a relationship between the plurality of attributes of each entry of the second data set and the plurality of attributes of each entry of the plurality of first data set. For each entry of the second data set, a plurality of fit scores each individually corresponding to each entry of the related data set is calculated. Based on the plurality of fit scores, and via an integer optimization model, a plurality of matches can be obtained from the related data set. A list of the plurality of matches may then be displayed on a graphical user interface.

In one embodiment, the first data set includes a plurality of asset profiles. In additional aspects, through the GUI, a user input comprising the selection of one or more asset profiles from the list of matches may be received. Accordingly, a plurality of asset insights for each of the one or more asset profiles identified by the user input may be displayed through the GUI based at least in part on the calculated plurality of fit scores.

In one aspect, a data describing an attribute weight for each of the plurality of attributes can be received from one or more data sources, such as a network, an information handling system, a non-transitory machine-readable storage medium, or other data sources as will be understood by those skilled in the art. An overall fit score individually corresponding to each of the plurality of matches for each entry in the second data set can then be determined based on the attribute weight for each of the plurality of attributes and the plurality of fit scores. Additionally, the overall fit score individually corresponding to each of the plurality of matches can then be displayed on the GUI.

In aspects, the plurality of attributes can include a plurality of qualifying criteria. Additionally, the plurality of qualifying criteria can include one or more of education level, availability, or selected documentation.

According to one example, the plurality of matches can be predicted via the integer optimization model, based on the determination of a sum of the plurality of fit scores individually corresponding to the plurality of subsets of the first data set over the plurality of attributes and one or more constraints. The one or more constraints can include one or more of a first data set defined correlation score quality threshold for the plurality of fit scores, a second data set defined correlation score quality threshold for the plurality of fit scores, a pre-defined correlation score quality threshold for the plurality of fit scores, a range of correlation per member of the first data set, and a range of correlation per member of the second data set. Additionally, the one or more constraints can include a plurality of bias constraints.

In some variations, data describing one or more additional data sets corresponding to the first data set or the second data set can be received from one or more data sources, such as a network, an information handling system, or a non-transitory machine-readable storage medium, or other data sources as will be understood by those skilled in the art. Furthermore, data pre-processing to convert the received data sets into a standard format corresponding to the plurality of attributes can then be performed.

In some variations, a plurality of fit scores, each individually corresponding to each entry of the first data set for each entry of the second data set can be calculated in response to an empty related data set. Based on the plurality of fit scores, and via an integer optimization model, a plurality of matches can then be determined from the first data set. A list of the plurality of matches may then be displayed on a graphical user interface.

In some embodiments, the total number of entries of the first data set may not be the same as the total number of entries of the second data set.

Another embodiment of the disclosure is directed to a system for determining a plurality of matches between a plurality of dissimilar data sets. The system may include a profile matching circuitry. The profile matching circuitry may be configured to obtain a second data set. The profile matching circuitry may be configured to pre-process the second data set including conversion of the second data set to a standard format corresponding to the plurality of attributes. The profile matching circuitry may be configured to determine a related data set of the first data set based on a relationship between the plurality of attributes of each entry of the second data set and the plurality of attributes of each entry of the first data set. The profile matching circuitry may be configured to determine a plurality of fit scores each individually corresponding to each entry of the related data set for each entry of the second data set. The system may include a modeling circuitry. The modeling circuitry may be configured to determine, via an integer optimization model, a plurality of matches from the related data set based on the plurality of fit scores. The modeling circuitry may be configured to execute a next action based on a list of the plurality of matches.

Another embodiment of the disclosure is directed to a method for determining a plurality of matches between a plurality of different data sets. The method may include obtaining a first data set. The method may include pre-processing the first data set to convert the first data set to a standard format associated with a plurality of attributes. The method may include determining a plurality of subsets corresponding to a second data set based on the plurality of attributes corresponding to the first data set. The method may include determining a plurality of sets of fit scores each associated with one of the plurality of subsets for the first data set. The method may include determining, via an integer optimization model, a plurality of matches from the plurality of subsets based on the plurality of sets of fit scores. The method may include displaying, on a graphical user interface (GUI), a list of the plurality of matches.

Another embodiment of the disclosure is directed to a method for training a model to determine a plurality of matches between a plurality of dissimilar data sets. The method may include obtaining a first data set and a second data set different than the first data set. The method may include pre-processing the first data set to convert the first data set to a standard format associated with a plurality of attributes. The method may include marking-up the first data set and the second data set. The method may include selecting matches between the first data set and the second data based on the marked-up first data set and marked-up second data set to generate a third data set. The method may include training a machine learning model with the first data set, the second data set, and the third data set. The method may include, in response to a trained machine learning model exceeding a testing threshold, transmitting the trained machine learning model to a computing device for use in matching dissimilar data sets. In another embodiment, the method may further include, prior to training, determining one or more constraints, and training the machine learning model is further based on the constraints.

Still other aspects and advantages of these embodiments and other embodiments, are discussed in detail herein. Moreover, it is to be understood that both the foregoing information and the following detailed description provide merely illustrative examples of various aspects and embodiments and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting of the scope of the disclosure.

The present disclosure can be better understood by referring to the following figure. This drawing illustrates the principles of the disclosure and no limitation of the scope of the disclosure is thereby intended.

FIG. 1 is a simplified diagram of a unit fulfillment system, according to an embodiment of the disclosure.

FIG. 2 is a simplified diagram that illustrates an apparatus for enhanced unit fulfillment, according to an embodiment of the disclosure.

FIG. 3 is a simplified diagram that illustrates training of a machine learning model for enhanced unit fulfillment, according to an embodiment of the disclosure.

FIG. 4A is a schematic diagram of a method or process for enhanced unit fulfillment.

FIG. 4B is a schematic diagram of a method or process related to application of data to a trained model.

FIG. 5 illustrates two charts showing the results of tests utilizing the systems and methods described herein.

### DETAILED DESCRIPTION

The foregoing aspects, features, and advantages of the present disclosure will be further appreciated when considered with reference to the following description of the embodiments and accompanying drawing. In describing the embodiments of the disclosure illustrated in the appended drawing, specific terminology will be used for the sake of clarity. The disclosure, however, is not intended to be limited to the specific terms used, and it is to be understood that each specific term includes equivalents that operate in a similar manner to accomplish a similar purpose. Numerous specific details, examples, and embodiments are set forth and described to provide a thorough understanding of various embodiments of the present disclosure. However, in certain instances, well-known or conventional details are not described in order to provide a concise discussion of embodiments of the present disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment,” “certain embodiments,” or “other embodiments” of the present disclosure are not intended to be interpreted as excluding the existence of additional embodiments that also incorporate the recited features. Furthermore, reference to terms such as “above,” “below,” “upper,” “lower,” “side,” “front,” “back,” or other terms regarding orientation are made with reference to the illustrated embodiments and are not intended to be limiting or exclude other orientations.

The term “many-to-many” correlations refers to a matching problem that involves deciding how to pair up agents belonging to two disjointed sets, for example, assets or job seekers and employers, where both can participate in multiple correlations up to a certain value, referred to, in an embodiment, as a quota.

The term “asset” can refer to an employee, a job seeker, a candidate to a position, or a potential user seeking a new role. Furthermore, the term “unit” can refer to a job position within a division or department, a job role within a division or department, or an assigned duty or responsibility to be held by an employee.

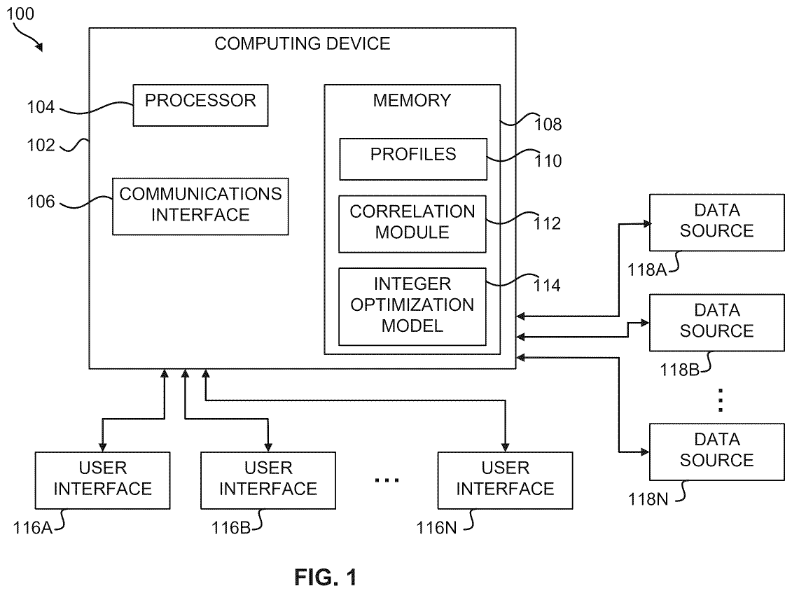

FIG. 1 is a simplified diagram of a unit fulfillment system, according to an embodiment of the disclosure. Such a system 100 may include a computing device 102. The computing device 102 may connect to one or more user interfaces 116A, 116B, and up to 116N and/or to one or more data sources 118A, 118B, and up to 118N. Such a connection may be facilitated by a communications circuitry 106 of the computing device 102. The computing device 102 may include a processor 104 and a memory 108.

The term “computing device” is used herein to refer to any one or all of servers, virtual computing device or environment, desktop computers, personal data assistants (PDAs), laptop computers, tablet computers, smart books, palm-top computers, personal computers, smartphones, virtual computing devices, cloud based computing devices, and similar electronic devices equipped with at least a processor and any other physical components necessarily to perform the various operations described herein. Devices such as smartphones, laptop computers, and tablet computers are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

As used herein, a “non-transitory machine-readable storage medium” or “memory” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. The memory may store or include instructions executable by the processor.

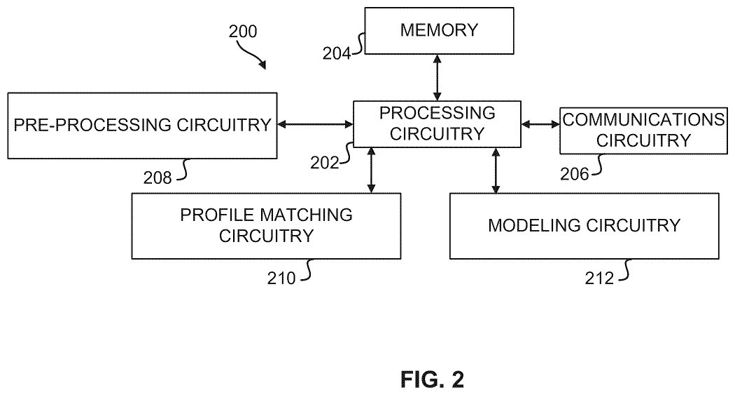

As used herein, a “processor” or “processing circuitry” may include, for example one processor or multiple processors included in a single device or distributed across multiple computing devices. The processor (such as, processor 104 and processing circuitry 202 shown in FIG. 1 and FIG. 2) may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As noted, the memory 108 may include instructions and/or may store data. In an embodiment, the memory 108 may store one or more data sets, profiles 110, or asset profiles. The one or more data sets, profiles 110, or asset profiles may include one or more data points related to and/or identifying a particular asset or person. For example, a profile may include a first name, last name, middle name, phone number, e-mail address, home address, an identification number and/or card (for example, the computing device 102 may determine or generate a unique random alphanumerical sequence that enables the computing device 102 to reference and/or search for a specific asset without accessing any of their personal information), a commute constraint (for example, data indicative of a maximum amount of time for a commute that an asset may travel to a job location), one or more different types of units of interest (for example, a list of units indicative of asset interest), one or more types of tasks of interests (in other words, a list of tasks indicative of asset interest), experience in tasks (for example, how much experience the asset has in a certain task), experience in a sector or technology (for example, how much experience the asset has in a selected industry and/or technology), skills (for example, a list of skills the asset possesses), languages (for example, a list of languages the asset speaks, as well as the corresponding level), education level, minimum salary (for example, the minimum compensation expected by the asset), remote preference (for example, if the asset prefers to work remotely and/or on-site), work days (for example, the days of the week the asset is available to work), work regime or type (for example, whether the asset is looking for full-time or part-time employment), shifts (for example, specific types of shift schedules the asset is available to work), and documents (for example, a list of documentation the asset possesses or does not possess, such as a resume, transcript, cover letter, recommendation letter, driver license or other identification documents, and/or other documents). In an embodiment, the one or more data sets may be structured as a linked data set or as a vector. Each entry in the data set may represent an asset or person. Each entry may further include a plurality of attributes, a subset of data, or data related to each entry. The computing device 102 may obtain such data from the one or more data sources 118A, 118B, and up to 118N. The computing device 102 may obtain and/or receive the profiles from one of the one or more user interfaces 116A, 116B, and up to 116N. For example, a user may submit an asset profile via one of the one or more user interfaces 116A, 116B, and up to 116N.

In an embodiment, the memory 108 may include a correlation module 112. The correlation module 112 may be circuitry and/or instructions that when executed is configured to determine a subset of the plurality of profiles (or, in other words, a subset of the plurality of assets) for a selected one or more units. A unit may also refer to a role and/or a job. In another embodiment, the correlation module 112 may correlate a subset of the first data set to a second data set to form a related data set. The correlation module 112 may determine the subset of the plurality of profiles based on one or more applying a filter to the plurality of profiles and/or determining a correlation between a set of attributes for a selected unit and the plurality of profiles. Further, the determination of the subset of the profiles may occur based on initiation via the one of the one or more user interfaces 116A, 116B, and up to 116N and/or based on submission of a new unit to the computing device 102. In an embodiment, the correlation may include correlating a profile to the plurality of attributes, profiles, and/or assets.

In an embodiment, prior to determining the subset of the plurality of profiles, the computing device 102 may pre-process the selected unit (and/or, in some embodiments, a plurality of units). Such a pre-processing of the selected unit(s) may include parsing the selected unit into a plurality of attributes and/or converting the selected unit(s) to a standard format.

In another embodiment, the correlation module 112 may determine a score for each asset or profile or each entry in the related data set based on a correlation between an asset and the unit or between the related data set and the second data set. Such a score may indicate whether an asset or profile should be added or included in the subset of the plurality of assets or profiles 110 for a selected unit. Such inclusion may further be based on whether the score exceeds a selected threshold. That threshold may be adjusted based on an average and/or mean of all scores for each of the assets and/or profiles.

Once a subset of the plurality of profiles is determined, the computing device 102 may apply the subset of the plurality of profiles or entries, the selected unit (and/or, in some embodiments, the description associated with the selected unit), and/or the plurality of attributes to a trained machine learning model and/or an integer optimization model 114. Such an application of the data to the trained machine learning model may produce a probability, a series of probabilities, a series of values, and/or a series of fit scores. In other embodiments, the output may be in the form of a vector, with values indicating an asset and a corresponding fit score. Such an output may indicate whether an entry, asset, and/or profile is a “best-fit”, is a match, and/or is correlated for the selected unit or entry of the second data set. As such, the computing device 102 may fulfill the selected unit and/or provide a recommendation as to which assets and/or profiles may fulfill the selected unit.

The machine learning model or integer optimization model 114 may include neural networks, supervised learning models, semi-supervised learning models, unsupervised learning models, or some combination thereof, as will be readily understood by one having ordinary skill in the art. In another embodiments, the integer optimization model 114 may be, rather than or in addition to a neural network, decision trees, support vector machines, hidden Markov models, Bayesian networks, linear regression, k-means, and/or tabular reinforcement learning. Specific neural networks that may be utilized include a recurrent neural network, such as a long short-term memory network.

Upon determination of which entry, assets, and/or profiles may be considered a “best-fit”, a match, or correlated and/or fulfillment of a unit, the computing device 102 may cause the interface to display a list of assets or an asset for the unit, for example, displaying such information via a graphical user interface (GUI), a web-based user interface, and/or via a mobile application.

In another embodiment, the related data set or subset of the assets or profiles may not include any matches. In other words, no correlation that meets a specified threshold may exist. In such embodiments, rather than generating fit scores for some subset of the first data set, the system 100 may generate fit scores for the entire first data set or set of assets or profiles and subsequently generate a best-fit, match, or correlation score or value.

In an embodiment, such a system 100 may be utilized for other relationship-based data sets. For example, the system 100 may determine matches and/or best-fit in forensic investigation scenarios (for example, determine matches between suspects and an offense, violation, crime, or other actionable occurrence). In another example, the system 100 may determine matches and/or best-fit in survey/consumer scenarios and/or other scenarios where matching may occur between data points in two dissimilar and/or different data sets.

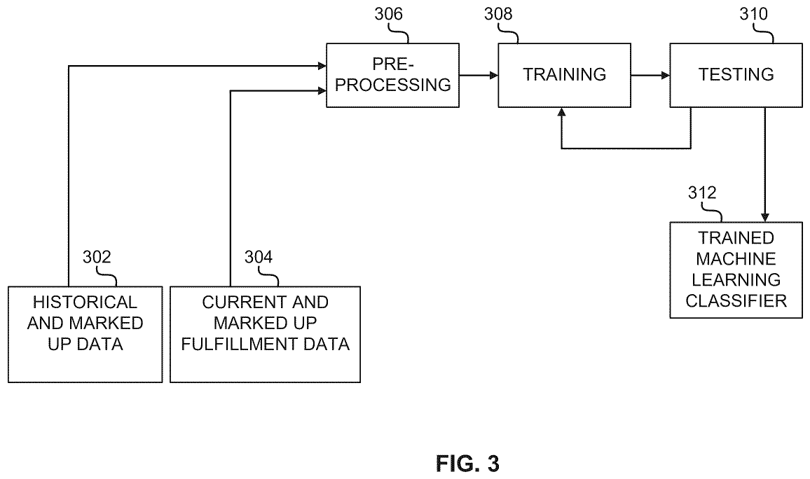

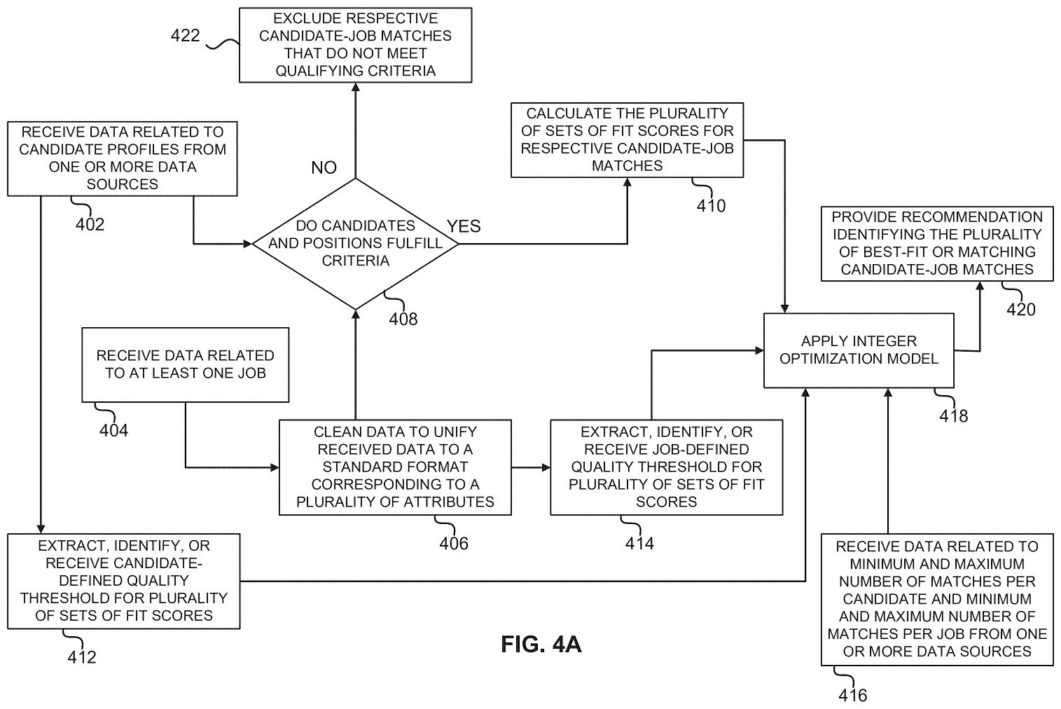

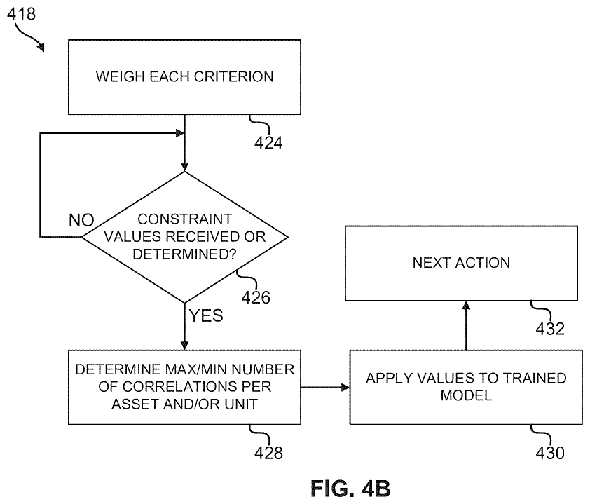

FIG. 2 is a simplified diagram that illustrates an apparatus for enhanced unit fulfillment, according to an embodiment of the disclosure. Such an apparatus 200 may be comprised of a processing circuitry 202, a memory 204, a communications circuitry 206, a pre-processing circuitry 208, a profile correlation circuitry 210, and a modeling circuitry 212, each of which will be described in greater detail below. While the various components are illustrated in FIG. 2 as being connected with processing circuitry 202, it will be understood that the apparatus 200 may further comprise a bus (not expressly shown in FIG. 2) for passing information amongst any combination of the various components of the apparatus 200. The apparatus 200 may be configured to execute various operations described herein, such as those described above in connection with FIG. 1 and below in connection with FIGS. 3-4.

The processing circuitry 202 (and/or co-processor or any other processor assisting or otherwise associated with the processor) may be in communication with the memory 204 via a bus for passing information amongst components of the apparatus. The processing circuitry 202 may be embodied in a number of unusual ways and may, for example, include one or more processing devices configured to perform independently. Furthermore, the processor may include one or more processors configured in tandem via a bus to enable independent execution of software instructions, pipelining, and/or multithreading.

The processing circuitry 202 may be configured to execute software instructions stored in the memory 204 or otherwise accessible to the processing circuitry 202 (e.g., software instructions stored on a separate storage device). In some cases, the processing circuitry 202 may be configured to execute hard-coded functionality. As such, whether configured by hardware or software methods, or by a combination of hardware with software, the processing circuitry 202 represents an entity (for example, physically embodied in circuitry) capable of performing operations according to various embodiments of the present disclosure while configured accordingly. Alternatively, as another example, when the processing circuitry 202 is embodied as an executor of software instructions, the software instructions may specifically configure the processing circuitry 202 to perform the algorithms and/or operations described herein when the software instructions are executed.

Memory 204 is non-transitory and may include, for example, one or more volatile and/or non-volatile memories. In other words, for example, the memory 204 may be an electronic storage device (for example, a computer readable storage medium). The memory 204 may be configured to store information, data, content, applications, software instructions, or the like, for enabling the apparatus 200 to carry out various functions in accordance with example embodiments contemplated herein.

The communications circuitry 206 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 206 may include, for example, a network interface for enabling communications with a wired or wireless communication network. For example, the communications circuitry 206 may include one or more network interface cards, antennas, buses, switches, routers, modems, and supporting hardware and/or software, or any other device suitable for enabling communications via a network. Furthermore, the communications circuitry 206 may include the processing circuitry for causing transmission of such signals to a network or for handling receipt of signals received from a network. The communications circuitry 206, in an embodiment, may enable reception of profiles, assets, asset profiles, selected units, selected jobs, and/or selected roles, among other data, and further, may enable transmission of best-fit, matching, or correlated assets and/or best-fit, matching, or correlated profiles for display via a user interface.

The apparatus 200 may include a pre-processing circuitry 208 configured to pre-process one or more data sets and/or data related to assets, people, candidates, units, roles, and/or jobs, thus producing a set of attributes for each one of the units, roles, and/or jobs. In another embodiment, the pre-processing circuitry 208 may convert data (one or more data sets and/or data related to assets, people, candidates, units, roles, and/or jobs) to a standard format. In an embodiment, the pre-processing circuitry 208 may store the set of attributes in memory 204 and may include an identifier with each of the attributes, the identifier corresponding to a selected unit. The pre-processing circuitry 208 may utilize processing circuitry 202, memory 204, or any other hardware component included in the apparatus 200 to perform these operations, as described above in connection with FIG. 1 and below in connection with FIGS. 3-4. The pre-processing circuitry 208 may further utilize communications circuitry 206 to transmit the plurality of attributes to the profile correlation circuitry 210.

The apparatus 200 may include a profile correlating circuitry 210 configured to determine a related data set or a subset of a plurality of profiles and/or assets that correlate with, relate to, or are correlated with the plurality of attributes for each of the units. The profile correlating circuitry 210 may utilize processing circuitry 202, memory 204, or any other hardware component included in the apparatus 200 to perform these operations, as described above in connection with FIG. 1 and below in connection with FIGS. 3-4. The profile correlating circuitry 210 may further utilize communications circuitry 206 to transmit the correlated profiles and/or assets to the modeling circuitry 212.

The apparatus 200 may include a modeling circuitry 212 configured to apply the plurality of attributes and the subset of the plurality of profiles and/or assets to a trained machine learning model to produce a best-fit, match, or correlation score for each of the profiles and/or assets. Such a score may be a series of values or a vector including probabilities for each profile or asset. The modeling circuitry 212 may utilize processing circuitry 202, memory 204, or any other hardware component included in the apparatus 200 to perform these operations, as described above in connection with FIG. 1 and below in connection with FIGS. 3-4. The modeling circuitry 212 may further utilize communications circuitry 206 to transmit the best-fit, matching, or correlated profiles or assets to a user interface for display.

Although components 202-212 are described in part using functional language, it will be understood that the particular implementations necessarily include the use of particular hardware. It should also be understood that certain of these components 202-212 may include similar or common hardware. For example, the pre-processing circuitry 208, the profile correlating circuitry 210, and the modeling circuitry 212 may, in some embodiments, each at times utilize the processing circuitry 202, memory 204, or communications circuitry 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the pre-processing circuitry 208, the profile correlating circuitry 210, and the modeling circuitry 212 may utilize processing circuitry 202, memory 204, or communications circuitry 206 as described above, it will be understood that any of these elements of apparatus 200 may include one or more dedicated processors, specially configured field programmable gate arrays (FPGA), or application specific interface circuits (ASIC) to perform its corresponding functions, and may accordingly utilize processing circuitry 202 executing software stored in a memory or memory 204, communications circuitry 206 for enabling any functions not performed by special-purpose hardware elements. In all embodiments, however, it will be understood that the pre-processing circuitry 208, the profile correlating circuitry 210, and the equipment and modeling circuitry 212 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200 (or by computing device 102). Furthermore, some example embodiments may be a computer program product comprising software instructions stored on at least one non-transitory computer-readable storage medium (such as memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

FIG. 3 is a simplified diagram that illustrates training of a machine learning model for enhanced unit fulfillment, according to an embodiment of the disclosure. The integer optimization model described herein, and/or any other model described herein, may be trained prior to use. Such training may be performed prior to use with a set of historical and marked-up data 302. In another embodiment, a machine learning model may be re-trained and/or refined via current and marked-up unit fulfillment data 304.

In embodiments, prior to training the machine learning model, data may be pre-processed 306. Pre-processing may include extraction of selected features via a natural language processing model. In other embodiments, the data received may not be marked up. In such embodiments, pre-processing 306 may include marking up the data. Marking up the data may include determining whether a selected instance within the data included a positive or negative outcome. A flag or indicator may be added to the data to indicate the type of outcome. In another embodiment, marking up the data sets may include generating a new data set based on two dissimilar data sets. For example, the first data set may correspond to applicants (for example, a set of applicants with varied backgrounds and diversities), while the second data set may correspond to open positions. The first and second data set may be utilized to create a third data set containing matches or best-fits. In other words, the third data set will include a list that contains the best-fit or matches based on unbiased data. Such steps may be performed algorithmically and/or by a user. In another embodiment, pre-processing 306 may include removing certain aspects within the profiles, for example, removing gender or race. In yet another embodiment, pre-processing 306 may include adjusting or altering portions of the data to neutralize potential bias. For example, a profile may potentially include language, anomalies, and/or errors that may indicate bias, including but not limited to grammatical and/or spelling errors (such as, due to a profile being based on an asset's non-native languages) and/or potential language or terms that indicates a gender and/or race. Pre-processing 306 may determine adjustments to the language, anomalies, and/or errors to remove any potential bias.

Subsequent to pre-processing 306, the data may be used to train a machine learning model (for example at 308). In embodiments, a portion of the data (for example, 70%, 80%, or 90%) may be fed to the machine learning model. The machine learning model may utilize the inputs versus the known desired outcome (such as target product content and properties) and/or known undesired outcome to “learn” what parameters can be utilized to reach the known desired outcome and what parameters lead to the known undesired outcome. Once the data has been used to train the machine learning model, then the remaining portion of the data set may be utilized to test 310 the trained machine learning model. If the trained machine learning model does not meet or achieve a selected error rate, then trained machine learning model may be re-trained or refined with a different randomized portion of the data set. In another embodiment, other training schema may be utilized. In another embodiment, readiness of the trained machine learning model may be determined based on how close the trained machine learning model comes to an expected outcome, based on the test data set. Once the trained machine learning model or classifier 312 meets a selected error rate, then the trained machine learning model may be released for further use.

FIG. 4A illustrates a schematic diagram of a method or process for correlating a plurality of dissimilar data sets. For example, a first data set can be received from one or more data sources, such as a network, an information handling system, a non-transitory machine-readable storage medium, or other data sources as will be understood by those skilled in the art. The first data set can include a plurality of subsets. In one embodiment, the plurality of subsets can refer to a plurality of asset profiles, where the term “asset” refers to an employee, a job seeker, a candidate for a position, or a potential user seeking a new role. Likewise, a second data set can be received from one or more data sources, such as a network, an information handling system, a non-transitory machine-readable storage medium, or other data sources as will be understood by those skilled in the art. The second data set can include data indicative of one or more subsets. In one embodiment, the one or more subsets can refer to one or more units, where the term ‘unit’ refers to a job position within a division or department, a job role within a division or department, or an assigned duty or responsibility to be held by an employee. For example, a data describing a plurality of asset profiles may be received. As shown in FIG. 4A, at 402, the plurality of asset profile data can be received from one or more data sources, such as via a network, from information handling systems, memory, via a user interface (for example, via a GUI or web-based UI displayed on a computing device and/or via a mobile application of a mobile computing device), and/or other data sources. For example, the plurality of asset profile data can be offered as part of the system or obtained through organizations that collect profiles of assets. In another example, the asset profiles may be stored in a database. The database may be actively updated via a corresponding GUI or web-based UI. An asset may enter information via a form and/or submit a file (for example, a text-based document), thus adding that asset's profile to the database and including that profile in the plurality of asset profiles.

In embodiments and as noted above, the received plurality of asset profile data can include a description of attributes highlighting an identification card (a unique randomly generated alphanumerical sequence that allows the tool to reference a specific asset without accessing any of their personal information), commute constraint (how long an asset is willing to commute to a job location), type of unit (one or more position titles that interest the asset), interest in tasks (tasks the asset is interested in performing), experience in tasks (how much experience the asset has in a certain task), experience in sector (how much experience the asset has in a certain industry), skills (a list of skills the asset possesses), languages (a list of languages the asset speaks, as well as the corresponding level), education level, minimum salary (the minimum compensation expected by the asset), remote preference (if the asset prefers to work remotely, on-site, or either), work days (what days of the week the asset is available to work), work regime (whether the asset looking for full-time or part-time employment), shifts (specific types of shift schedules the asset is open to), and documents (a list of documentation the asset possesses or does not possess). The profiles may include additional data and/or files, such as a resume, a cover letter, and/or other documents.

Likewise, at 404, data describing at least one unit or job can be received from one or more data sources, such as network, information handling systems, memory, and/or via a user interface. Further, at 404, unit or job data may be received or obtained from a spreadsheet, a word document, a PDF file, or an Applicant Tracking System (ATS). Further, unit or job data may be received from a user interface associated with a provider or organization. In yet another embodiment, the unit or job data may be received or obtained via an interactive form displayed via a GUI or web-based UI associated with a provider or organization.

According to an embodiment of the present disclosure, a data pro-processing may be performed to pre-process or convert the received data describing the at least one unit or job to a standard format corresponding to a plurality of attributes. In embodiments, the pre-processed received data at 406, can include a description of attributes highlighting an identification card (a unique randomly generated alphanumerical sequence that represents a specific job opening), type of unit (the position title), tasks required (the tasks that are expected to be performed in this role), desired experience in tasks (how much experience is expected of an asset in each task in terms of how long they have performed it), desired experience in the sector (how much experience is expected of an asset in the job's industry in terms of how long they have worked in it), skills (a list of skills an ideal asset possesses), languages (a list of languages an asset should speak, as well as the corresponding level of proficiency), required education level, salary (the unit's proposed compensation), remote obligation (whether the unit requires remote or on-site work), work days (what days of the week the asset is expected to work), work regime (whether the unit is full-time or part-time employment), shifts (the shift schedule of the job), and required documents (a list of documentation the asset must possess). In embodiments, the data cleaning may include parsing the received units or jobs and generating a list comprising the set of attributes for the unit or job. In other embodiments, the output of the data cleaning may include a vector. Other formats may be utilized for the set of attributes.

In some embodiments, some or all of these asset and unit attributes may provide the qualifying criteria for assessing whether the asset is feasible for matching or correlation, as assessed at 408. For example, in some embodiments, required education level (whether the asset possesses at least the minimum education level required by the unit), availability (whether the unit opening fulfills the asset's requirements in the attributes of remote preference, work days, work regime, and shifts), and required documents (whether the asset indicates possession of all the necessary documents listed by the unit opening) serve as qualifying criteria as assessed at 408. Other parameters or data points described herein may be utilized to determine a match or correlation.

In an embodiment, if the asset-unit correlation fulfills the threshold qualifying criteria, at 408, the asset profiles data associated therewith may be submitted or otherwise provided as feasible correlations. Under such a condition, aᵢⱼ, a binary indicator of the feasibility of correlating asset i to unit j, is said to take the value of 1. At 410, the asset and unit attributes are used to calculate the fit scores that represent the compatibility level between asset i and unit j for each of the plurality of feasible asset profiles. For such calculations, the term sᵢⱼ^{c}, referenced below, refers to the fit score of asset i and unit j in criterion c. If the type of unit j is listed by i, then sᵢⱼ¹ is set to one; otherwise sᵢⱼ¹ is set to zero. The fit score for the similarity between the tasks asset i is interested in and the tasks required by unit j, sᵢⱼ², may be calculated using the Jaccard Index. The Jaccard Index, measuring the similarity between the set of tasks listed by asset i and those listed by unit j, may be formulated as follows:

$$J ( {T}_{i} , Tj ) = \frac{\vert {T}_{i} ⋂ Tj \vert}{( \vert {T}_{i}} ⋃ Tj \vert )$$

The fit score for the desire experience in tasks listed by unit j, sᵢⱼ³, may be calculated using a fulfilment index. The fulfillment index is the ratio between asset i self-assessed value and the desired value listed by unit j, up to an upper limit of 1, which would mean total fulfillment. Here, sᵢⱼ³ corresponds to the average of the fulfillment index for each desired experience in tasks listed by unit j. Likewise, sᵢⱼ⁴ is the fulfillment index of asset i with respect to unit j desired industry experience, sᵢⱼ⁵ is the average of the fulfillment index of each desired language listed by unit j, and sᵢⱼ⁶ is the fulfillment index of asset i with respect to unit j's desired education level. Further, in an embodiment, sᵢⱼ⁷, the fit score pertaining to the asset's commute constraint attribute, when compared to a desired maximum value, may be formulated as follows:

$${s}_{ij}^{7} = {log}_{10} ( 1 + 9 ma ( 0 , min ( 1 , 1 - \frac{commute time ( i , j )}{commute limit ( i )} ) ) )$$

intuition is that

$${s}_{ij}^{7}$$

ranges from 0, for a commute time greater than or equal to the maximum desired, and to 1 for no commute time. Additionally, the fit score for the last criterion, referring to salary,

$${s}_{ij}^{8} ,$$

may be formulated as follows:

$${s}_{ij}^{8} = max ( 0 , min ( 1 , ( \frac{salary ( j )}{requested salary ( i )} - \text{.9} ) ) )$$

Here,

$${s}_{ij}^{8}$$

ranges from, 0 when a salary is less than 90% of the asked value asked by asset i, and to 1 when the value is greater than or equal to 1.9 times the asked value by asset i.

According to an embodiment of the present disclosure, at 412, data describing a plurality of constraints related to an asset-defined correlation score quality threshold for the plurality of sets of fit scores may be extracted, received, or identified from the data describing the plurality of asset profile data at 402. For example, at 412, the minimum desired correlation score quality threshold, as desired by each of the plurality of assets, may be received, extracted, or identified.

According to an embodiment of the present disclosure, at 414, data describing a plurality of constraints related to a unit-defined correlation score quality threshold for the plurality of sets of fit scores may be extracted, received, or identified from the data describing the at least one unit at 404. For example, at 414, the minimum desired correlation score quality threshold, as desired by each of the at least one unit, may be received, extracted, or identified.

According to an embodiment of the present disclosure, at 416, data describing a plurality of constraints related to a minimum and maximum number of correlations per asset and a minimum and maximum number of correlations per unit may be received. For example, as shown in FIG. 4A, at 416, the plurality of constraints related to the minimum and maximum number of correlations per asset and the minimum and maximum number of correlations per unit may be received from one or more data sources, such as network, information handling systems, memory, or other data sources as will be understood by those skilled in the art. For example, the minimum and maximum number of correlations per asset and the minimum and maximum number of correlations per unit can be offered as part of the system to serve as a lower bound on the number of correlations per asset lᵢ, an upper bound on the number of correlations per asset uᵢ, a lower bound on the number of correlations per unit lⱼ, and an upper bound on the number of correlations per asset uⱼ within the integer optimization model. In some embodiments, the minimum and maximum number of correlations per asset and the minimum and maximum number of correlations per unit can be extracted, received, or identified at 412 for the plurality of asset profiles, and at 414 for the at least one unit, to serve as a lower bound on the number of correlations per asset lᵢ, an upper bound on the number of correlations per asset uᵢ, a lower bound on the number of correlations per unit lⱼ, and an upper bound on the number of correlations per asset uⱼ within the integer optimization model.

According to an embodiment of the present disclosure, the plurality of constraints received at 412, 414, and 416 may be processed as parameters in applying the integer optimization model at 418. For example, the integer optimization model may be formulated as follows:

$$F = {\sum }_{c ∈ C} {ω}_{c} {\sum }_{i ∈ I} {\sum }_{j ∈ J} {s}_{ij}^{c} - {x}_{ij} - {\sum }_{i ∈ I} ( α {i}_{} + {β}_{i} ) - {\sum }_{j ∈ J} ( γ {j}_{} + {δ}_{j} )$$

Accordingly, the weight of each criterion ω_{c} can be received from one or more data sources, such as network, information handling systems, memory, or other data sources as will be understood by those skilled in the art. Furthermore, the purpose of ϵ is to ensure that a correlation fit score is smaller than one.

Here, ω_{c} represents the user-defined weight of each asset and unit attribute used to calculate the fit scores that represent the compatibility level between asset i and unit j for each of the plurality of feasible asset profiles. Accordingly, the weight of each criterion ω_{c} can be received from one or more data sources, such as network, information handling systems, memory, or other data sources as will be understood by those skilled in the art. Further, ω_{c} must add up to 1−ϵ, where ϵ is a small number greater than zero. The purpose of ϵ is to ensure that a correlation fit score is strictly smaller than one. Furthermore,

$${s}_{ij}^{c}$$

represents the fit score of the asset i and unit j in attribute c, used to calculate the fit scores that represent the compatibility level between asset i and unit j for each of the plurality of feasible asset profiles. Additionally, xᵢⱼ serve as binary variables activated and set to 1 when feasible asset i is correlated to unit j. The term αᵢ is a violation variable that allows for the violations of an asset i lower bound (the minimum number of correlations per asset) obtained at 416 if it resolves infeasibility. The term βᵢ is a violation variable that allows for the violations of the of an asset i upper bound (the maximum number of correlations per asset) obtained at 416 if it resolves infeasibility. The term γⱼ is violation variable that allows for the violations of a unit j lower bound (the minimum number of correlations per unit) obtained at 416 if it resolves infeasibility. The term δⱼ is violation variable that allows for the violations of a unit j upper bound (the maximum number of correlations per unit) obtained at 416 if it resolves infeasibility. Further, the application of the integer optimization model at 418 may be subject to a plurality of constraints. The first of these constraints may be formulated as follows:

$${x}_{ij} \leq {α}_{ij} \qquad ∀ i , ∀ j$$

Here, αᵢⱼ is a binary indicator of feasibility of correlating asset i∈I to unit j∈J. This constraint forbids infeasible correlations to occur based on the pre-calculated feasibility indicator αᵢⱼ. That is, the binary variable xᵢⱼ can take a value of 1 only if binary parameter αᵢⱼ is also 1. The second of these constraints may be formulated as follows:

$${x}_{ij} \leq 1 - ( {t}_{ij} - {\sum }_{c ∈ C} {ω}_{c} {s}_{ij}^{c} ) \qquad ∀ i ϵ I , ∀ j ϵ j$$

Here, tᵢⱼ is a parameter representing the minimum correlation quality threshold between asset i and unit j. Each asset i, as obtained at 412, and unit j, as obtained at 114, define their minimum desired correlation score quality threshold. Accordingly, the minimum calculated fit score required for an asset i to match a unit j, referred to here as tᵢⱼ, is defined as the larger of the correlation score quality thresholds required by the asset i and by the unit j. For example, an asset i is said to correlate to unit j if the larger of the correlation score quality thresholds required by the asset i, obtained at 412, and the unit j, obtained at 114 is met. Hence, this constraint defines that a correlation can only take place if its fit score is above the specified threshold tᵢⱼ. Consequently, under this constraint, when the weighted sum of fit scores

$${s}_{ij}^{c}$$

over all criteria is smaller than the threshold tᵢⱼ, the right-hand side of the inequality will be less than one, therefore ensuring xᵢⱼ is zero. Otherwise, the right-hand side will be greater than or equal to one, not imposing any restriction on xᵢⱼ.

According to an embodiment of the present disclosure, the application of the integer optimization model may also include constraints on a minimum and/or maximum number of correlations per asset and a minimum and/or maximum number of correlations per unit. For example, as shown in FIG. 4A, the minimum and maximum number of correlations per unit constraints, obtained at 416, may be provided as two of the plurality of constraints when applying the integer optimization model at 418. Such a constraint may be formulated as follows:

$$\begin{matrix}lj - {γ}_{j} \leq {\sum }_{i ϵ I} {x}_{ij} \leq {u}_{j} + {δ}_{j} & ∀ j ϵ J\end{matrix}$$

Here, as noted above, lⱼ represents the minimum number of correlations per unit (a lower bound on the number of correlations per unit), uⱼ represents the maximum number of correlations per unit (an upper bound on the number of correlations per unit), γⱼ is the violation variable that allows for the violations of a unit j lower bound, and δⱼ is the violation variable that allows for the violations of a unit j upper bound.

As noted above, the application of the integer optimization model at 418 may also include a plurality of constraints that impose restrictions on the minimum and/or maximum number of correlations per asset. For example, as shown in FIG. 4A, the minimum and maximum number of correlations per asset constraints, obtained at 416, may be provided as two of the plurality of constraints when applying the integer optimization model at 418. Such a constraint may be formulated as follows:

$${l}_{i} - {a}_{i} \leq {\sum }_{j ϵ J} {x}_{ij} \leq {u}_{i} + {β}_{i} \qquad ∀ i ϵ I$$

Here, as noted above, lᵢ represents the minimum number of correlations per asset (a lower bound on the number of correlations per asset), uᵢ represents the maximum number of correlations per asset (an upper bound on the number of correlations per asset), aᵢ is the violation variable that allows for the violations of an asset i lower bound, and βᵢ is the violation variable that allows for the violations of the of an asset i upper bound. However, in some embodiments, with respect to correlations per asset, the application of the integer optimization model at 418 may restrict only the maximum number of correlations per asset uᵢ (the upper bound on the number of correlations per asset). This constraint may be formulated as follows:

$${\sum }_{j ϵ J} {x}_{ij} \leq {u}_{i} + {β}_{i} \qquad ∀ i ϵ I$$

Alternatively, in some embodiments, with respect to correlations per asset, the application of the integer optimization model at 418 may restrict only the minimum number of correlations per asset lᵢ (the lower bound on the number of correlations per asset). This constraint may be formulated as follows:

$${l}_{i} - {a}_{i} \leq {\sum }_{j ϵ J} {x}_{ij} \qquad ∀ i ϵ I$$

According to an embodiment of the present disclosure, the integer optimization model may also include a plurality of bias constraints. Such constraints in applying the integer optimization model at 418 may include one or more of the constraints formulated as follows:

$$\begin{matrix}{x}_{ij} ϵ \{ 0 , 1 \} & ∀ i ϵ I , ∀ j ϵ J \\ {γ}_{j} ϵ \{ 0 , … , {l}_{j} \} & ∀ j ϵ J \\ {δ}_{h} ϵ {Z}^{+} & ∀ j ϵ J \\ {a}_{i} ϵ \{ 0 , … , {l}_{i} \} & ∀ i ϵ I \\ {β}_{i} ϵ {Z}^{+} & ∀ i ϵ I\end{matrix}$$

Here, as noted above, xᵢⱼ serve as binary variables. As noted above, the violation variables α, β, γ, and δ are variables allowing for a penalized violation of a plurality of constraints, only if it resolves infeasibility. These variables may take nonzero values in multiple scenarios. For example, if a certain asset i does not have enough feasible and above-threshold correlation options to meet the minimum number of correlations per asset requirement obtained at 416, then aᵢ will be positive. Likewise, if a certain unit j does not have enough feasible and above-threshold correlation options to meet the minimum number of correlations per unit requirement obtained at 416, then γⱼ will be positive. Additionally, if scarcity causes assets to compete for units to achieve their minimum number of correlations, then violation variable δⱼ allows the maximum number of correlations for unit j to be increased subject to a penalty in the integer optimization model objective function. Likewise, if scarcity causes units to compete for assets to achieve their minimum number of correlations, then violation variable βᵢ allows the maximum number of correlations for asset i to be increased subject to a penalty in the integer optimization model objective function. Furthermore, the plurality of bias constraints, as noted above, ensure the violation variables α, β, γ, and δ assume only nonnegative integer values. Additionally, the penalties aᵢ and γⱼ can assume at most the values of lᵢ and lⱼ, respectively.

According to an embodiment of the present disclosure, at 420, data describing a plurality of best-fit or matching asset-unit correlations may be identified after applying the integer optimization model at 418. In some embodiments, the identified plurality of best-fit or matching assets (subsequently referred to as matching) may be displayed on a graphical user interface as a list of the plurality of matching assets each with an overall fit score. In another embodiment, in response to determination of the plurality of best-fit or matching asset-unit correlations or a list of the plurality of best-fit or matching asset-unit correlations, the method may include executing a next action based on the plurality of best-fit or matching asset-unit correlations or a list of the plurality of best-fit or matching asset-unit correlations. Such an action may include automatically submitting one or more different assets or applicants' resume for a selected job, displaying the list the plurality of best-fit or matching asset-unit correlations or a list of the plurality of best-fit or matching asset-unit correlations via a GUI, filter and rank assets and/or jobs, and/or request approval of application submission from corresponding assets or applicants. Furthermore, the overall fit score for each asset-unit correlation presented at 420 may correspond to the weighted sum of fit scores

$${s}_{ij}^{c}$$

over all criteria for asset i anu unit j, which may be formulated as follows:

$${\sum }_{c ϵ C} {ω}_{c} {s}_{ij}^{c}$$

Furthermore, at 420, the graphical user interface may display a plurality of asset insights describing the profile of each of the plurality of matching assets and/or their fit scores in each criterion.

According to an embodiment of the present disclosure, at 422, the plurality of asset profiles not qualifying as part of the plurality of feasible asset profiles, for failing to meet the qualifying criteria at 408, may be excluded. As noted above, the exclusion of assets not falling within the plurality of feasible asset profiles is represented within the integer optimization model and the plurality of constraints by the binary indicator aᵢⱼ.

According to the embodiment of the present disclosure, the results of the match Quality obtained by the integer optimization model is given by the following formula, where the fit score for a candidate-job pair is a value between zero and one.

$$E [ Match Quality ] = \frac{1}{k} {\sum }_{k ( Fit score of match i )} \times ( Prob . of reciprocal interest )$$

TABLE 1
Experimental results for efficiency and match quality

| | % Top-k Matched Candidates | | Expected Match Quality | |
|---|---|---|---|---|
| | Traditional | | Traditional | |
| Market | Recommendation | Our | Recommendation | Our |
| Size | System | Method | System | Method |
| 100 | 75% | 99% | 0.43 | 0.51 |
| 200 | 69% | 100% | 0.43 | 0.55 |
| 300 | 63% | 100% | 0.41 | 0.56 |
| 400 | 61% | 100% | 0.41 | 0.58 |
| 500 | 56% | 100% | 0.38 | 0.58 |

As illustrated in Table 1, in, for example, a market size of 500 jobs, 56% of candidates received realistic top k recommendations from traditional recommendation systems. In other words, almost half of the candidates may sort through a large number of rejections before receiving notification from the jobs to which they apply. When using the methods and systems described herein, 100% of candidates were able to access their top k recommended jobs that had a high likelihood of resulting in positive outcomes (for example, interview and hiring). A symmetric effect happens with job openings, meaning the market-based approach described herein reduces by almost 50% the number of candidates that need to be contacted before retrieving those that are truly interested in the opening, greatly increasing the efficiency of the recruitment process.

In another embodiment, at 416, each asset or candidate may be evaluated in relation to each job or position currently available or available in a selected database. Such an evaluation may include determining, via, for example, the integer optimization model or another model, each candidates fit in relation to those jobs or positions. In some examples, an asset, user, or candidate may be a fit for many of the jobs. After such a determination, the integer optimization model or another model, in such embodiments, may solve a max-weight problem matching problem. Thus, each candidate is evaluated for a fit based on each other candidates fit for each job. Further, “super” candidates (in other words, candidates that fit many jobs) may be matched to some top number of jobs, freeing the remaining jobs for other candidates to match with. Such a top number may include 3 or more jobs. Further, the integer optimization model or another model may sum all fits determined by the integer optimization model or another model, which may be considered the global utility. The sum of all candidate utilities may be utilized to find the group utility. The utilities can be determined as follows: an individual candidate who receives from the system two matches of high fit (e.g. 0.98 fit each, on a scale from 0 to 1), obtains an individual utility of 0.98+0.98=1.96, for example. Therefore, the higher the number of matches obtained by a candidate and their respective fit scores, the higher the resulting utility for an individual. Group utilities may be determined by the sum of the utilities of individuals in the group. The global utility may be the sum of utilities obtained by all the assets in the system. The global utilities may be interpreted as the overall welfare obtained from the recommendation system. Group utilities from different methods may be used to analyze fairness in the distribution of welfare between different groups of assets. Significant gaps between utilities of groups of similar sizes and qualification should be analyzed for the potential presence of bias. Global utilities are mainly used to make sure a more balanced outcome does not cause any significant decrease to the sum of positive overall welfare for all assets being analyzed.

To determine the efficacies of such methods and systems, the outcomes described above are observed for four types of matchings. The first type of matching occurs when a minority group is the only group in the market being matched to the available jobs. Such a case is used only as a reference to assess what may be the best possible or optimal outcomes for candidates and employers in this example. The second type of matching includes regular matching systems, using usual predictive AI models and other ranking methods to match candidates to jobs (in other words, regular competition). In regular matching, certain groups may be more affected than others, thus without biasing those groups may not receive equal employment opportunities as others.

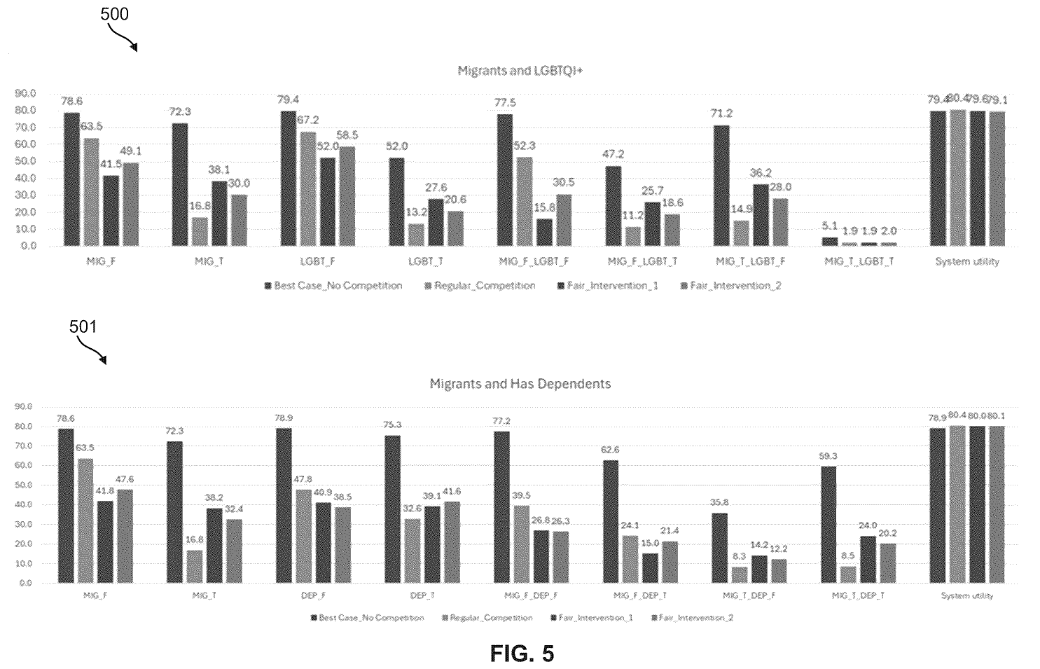

The two other matching strategies that are assessed include different interventions to balance the outcomes for different groups, while still maintaining the quality of matches. In such instances, not all groups are required to be hired at the same rate, as such a requirement may affect the ability to provide compatible matches for candidates and employers. The systems and method described herein, however, proved to increase welfare for the most severely impacted groups, while still maintaining a similar level of number and quality of matches for all candidates and employers, as displayed by the system utility in the rightmost corner of the chart 500 in FIG. 5. The same pattern is seen when analyzing different disadvantaged intersectionalities, as shown in chart 501. For reference, the charts 500 and 501 illustrate the fits (see the y-axis of charts 500 and 501, for example, migrants and LGBT candidates, among others) for a number of candidates (see the x-axis of charts 500 and 501). Each bar for each type of candidates represents a different scenario (for example, no competition, regular competition, and fairness interventions).

FIG. 4B is a schematic diagram of a method 418 or process related to application of data to a trained model. Such a method 418, at block 424, may include weighing each criterion in a job. In an embodiment, the weights for each criterion may be received from a data source or memory. In another embodiment, the weights may be determined based on previously used weights for similar criterion.

At block 426, the method 418 may include determining and/or receiving constraint values. For example, the method 418 may include determining infeasible correlations and/or determining a minimum correlation quality threshold, among other potential constraints. At block 428, the method 418 may include determining a maximum and minimum number of correlations per asset and/or unit. In an embodiment, such a minimum and maximum may be another constraint.

Once the constraints are received and/or determined, at block 430, the method 418 may include applying the values previously determined, including each data set, to the trained model. In such an embodiment, the constraints and the sets of data (for example, jobs and applicants) may be applied to the model to generate a list of “best-fit” or matching assets/units. The trained model, at block 432, may include determining a next action based on the best-fit or matching assets/units. The next action may include automatically submitting one or more different assets or applicants' resume for a selected job, displaying the list the plurality of best-fit or matching asset-unit correlations or a list of the plurality of best-fit or matching asset-unit correlations via a GUI, filter and rank assets and/or jobs, and/or request approval of application submission from corresponding assets or applicants

This application claims priority to, and the benefit of U.S. Provisional Application No. 63/679,610, filed Aug. 5, 2024, titled “SYSTEMS AND METHODS FOR DETERMINING A PLURALITY OF BEST-FIT CORRELATIONS BETWEEN A PLURALITY OF DISSIMILAR DATA SETS,” the disclosure of which is incorporated herein by reference in its entirety.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, and variations to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present invention as set forth in the appended claims.

What is claimed is:

1. A system for determining a plurality of matches between a plurality of dissimilar data sets, the system comprising:
a profile matching circuitry configured to:
obtain a second data set,
pre-process the second data set including conversion of the second data set to a standard format corresponding to the plurality of attributes,
determine a related data set of the first data set based on a relationship between the plurality of attributes of each entry of the second data set and the plurality of attributes of each entry of the first data set, and
determine a plurality of fit scores each individually corresponding to each entry of the related data set for each entry of the second data set; and
a modeling circuitry configured to:
determine, via an integer optimization model, a plurality of matches from the related data set based on the plurality of fit scores, and
execute a next action based on a list of the plurality of matches.

2. The system of claim 1, wherein the first data set includes a plurality of asset profiles, and wherein the plurality of asset profiles each include one or more asset profile aspects.

3. The system of claim 2, wherein execution of the next action comprises automatically submitting one or more different assets application for a job, displaying the list the plurality of matches via a graphical user interface (GUI), filter and rank assets and jobs, or request approval of application submission from corresponding assets or applicants and wherein the profile matching circuitry is further configured to:
receive, via the GUI, a user input comprising a selection of one or more asset profiles from the list of the plurality of best-fit correlations; and
display a plurality of asset insights for each of the one or more asset profiles identified by the user input based on the plurality of fit scores.

4. The system of claim 1, wherein the modeling circuitry is further configured to:
receive data describing an attribute weight for each of the plurality of attributes;
determine an overall fit score individually corresponding to each of the plurality of best-fit correlations for each entry in the second data set based on the attribute weight for each of the plurality of attributes and the plurality of fit scores; and
display, on the GUI, the overall fit score individually corresponding to each of the plurality of best-fit correlations.

5. The system of claim 1, wherein the second data set includes data indicative of one or more units.

6. The system of claim 1, wherein the plurality of attributes includes a plurality of qualifying criteria.

7. The system of claim 6, wherein the plurality of qualifying criteria includes one or more of education level, availability, or selected documentation.

8. The system of claim 1, wherein the integer optimization model predicts the plurality of best-fit correlations based on determination of a sum of the plurality of fit scores individually corresponding to a plurality of subsets of the first data set over the plurality of attributes and a one or more constraints.

9. The system of claim 8, wherein the one or more constraints include one or more of a first data set defined correlation score quality threshold for the plurality of fit scores, a second data set defined correlation score quality threshold for the plurality of fit scores, a pre-defined correlation score quality threshold for the plurality of fit scores, a range of correlations per member of the first data set, and a range of correlations per member of the second data set.

10. The system of claim 8, wherein the one or more constraints include a plurality of bias constraints.

11. The system of claim 1, wherein the profile matching circuitry is further configured to:
receive a third data set describing one or more additional data sets corresponding to the first data set or the second data set; and
pre-process the third data set to convert the third data set to a standard format corresponding to the plurality of attributes.

12. The system of claim 1, wherein the modeling circuitry is further configured to:
in response to an empty related data set:
determine a plurality of fit scores each individually corresponding to each entry of the first data set for each entry of the second data set,
determine, via an integer optimization model, a plurality of best-fit correlations from the first data set based on the plurality of fit scores, and
display, via a graphical user interface (GUI), a list of the plurality of best-fit correlations.

13. The system of claim 1, wherein the profile matching circuitry is further configured to:
obtain the first data set; and
pre-process the first data set including conversion of the first data set to a standard format corresponding to the plurality of attributes.

14. The system of claim 1, wherein a total number of entries of the first data set comprises a number different than the total number of entries of the second data set.

15. A method for determining a plurality of matches between a plurality of different data sets, the method comprising:
obtaining a first data set;
pre-processing the first data set to convert the first data set to a standard format associated with a plurality of attributes;
determining a plurality of subsets corresponding to a second data set based on the plurality of attributes corresponding to the first data set;
determining a plurality of sets of fit scores each associated with one of the plurality of subsets for the first data set;
determining, via an integer optimization model, a plurality of matches from the plurality of subsets based on the plurality of sets of fit scores; and
displaying, on a graphical user interface (GUI), a list of the plurality of matches.

16. The method of claim 15, wherein the plurality of subsets corresponds to a plurality of asset profiles, and wherein the plurality of asset profiles each include one or more asset profile aspects.

17. The method according to claim 16, further comprising:
receiving, via the GUI, a user input of a selection of one or more correlations from the list of the plurality of matches; and
displaying a plurality of asset insights for each of the one or more correlations identified by the user input based at least in part on the plurality of sets of fit scores.

18. The method according to claim 15, further comprising:
receiving data indicative of an attribute weight for each of the plurality of attributes;
determining an overall fit score individually corresponding to each of the plurality of matches for the first data set based on the attribute weight for each of the plurality of attributes and the plurality of sets of fit scores; and
displaying, on the GUI, the overall fit score individually corresponding to each of the plurality of matches.

19. The method of claim 15, wherein the first data set includes data indicative of one or more units.

20. The method according to claim 15, wherein the plurality of attributes includes a plurality of qualifying criteria.

21. The method according to claim 20, wherein the plurality of qualifying criteria includes at least one of education level, availability, or selected documentation.

22. The method of claim 15, wherein the integer optimization model predicts the plurality of matches based on determination of a sum of the plurality of sets of fit scores individually corresponding to the plurality of subsets over the plurality of attributes and a one or more constraints.

23. The method according to claim 22, wherein the one or more constraints include one or more of a first data set defined correlation score quality threshold for the plurality of sets of fit scores, a second data set defined correlation score quality threshold for the plurality of sets of fit scores, a pre-defined correlation score quality threshold for the plurality of sets of fit scores, a range of correlations per member of the first data set, and a range of correlations per member of the second data set.

24. The method of claim 22, wherein the one or more constraints include a plurality of bias constraints.

25. The method according to claim 15, further comprising:
receiving a third data set describing one or more additional data sets corresponding to the first data set or the second data set; and
pre-processing the third data set to convert the third data set to a standard format corresponding to the plurality of attributes.

26. The method according to claim 15, further comprising:
determining a plurality of sets of fit scores each individually corresponding to each entry of the second data set for each entry of the first data set,
determining, via an integer optimization model, a plurality of matches from the second data set based on the plurality of sets of fit scores, and
displaying, via a graphical user interface (GUI), a list of the plurality of matches correlations.

27. The method according to claim 15, further comprising:
pre-processing the second data set to a standard format corresponding to the plurality of attributes prior to determining a plurality of subsets.

28. The method of claim 15, wherein a total number of entries of the first data set comprises a number different than the total number of entries of the second data set.

29. A method for training a model to determine a plurality of matches between a plurality of dissimilar data sets, the method comprising:
obtaining a first data set and a second data set different than the first data set;
pre-processing the first data set to convert the first data set to a standard format associated with a plurality of attributes;
marking-up the first data set and the second data set;
selecting matches between the first data set and the second data based on the marked-up first data set and marked-up second data set to generate a third data set;
training a machine learning model with the first data set, the second data set, and the third data set; and
in response to a trained machine learning model exceeding a testing threshold, transmitting the trained machine learning model to a computing device for use in matching dissimilar data sets.

30. The method of claim 29, further comprising, prior to training:
determining one or more constraints, and wherein training the machine learning model is further based on the constraints.
